(19) United States
(12) Patent Application Publication
(10) Pub. No.: US 2013/0197807 A1
(43) Pub. Date: Aug. 1, 2013

(54) SYSTEM, METHOD AND COMPUTER PROGRAM PRODUCT FOR QUANTIFYING HAZARD RISK

(71) Applicants: Wei DU, Springfield, VA (US); Mark DROLLINGER, Cedar Park, TX (US); Jason STRADTNER, Leander, TX (US)

(72) Inventors: Wei DU, Springfield, VA (US); Mark DROLLINGER, Cedar Park, TX (US); Jason STRADTNER, Leander, TX (US)

(21) Appl. No.: 13/362,920

(22) Filed: Jan. 31, 2012

(51) Int. Cl. G06F 19/00

(52) U.S. Cl. 702/5

(57) ABSTRACT

A system, method and computer program product cooperate to quantify a hazard risk, such as a flood risk, for a property. A mobile device, with a GPS module, to record specific locations on a property, each of which may be used in identifying a flood risk score (FRS). Using multiple specific locations on a property are valuable in that better resolution and assessment of potential damage to an improvement, such as a building, on that parcel, as opposed to using only a single parcel centroid for assessing the risk for the entire parcel. Moreover, if only a single point, such as the centroid of a parcel, is used for assessing the flood risk of the entire parcel, the risk assessment may be overlooking the possibility of more vulnerable (and valuable) portions of the parcel to flood damage.

### CROSS-REFERENCE TO RELATED PATENT DOCUMENTS

The present application contains subject matter related to U.S. Pat. No. 7,917,292, issued Mar. 29, 2011, and U.S. patent application ser. No. 12/027,096 the entire contents of both of which being incorporated herein by reference in their entirety.

### BACKGROUND

1. Technical Field

The present description relates to systems, methods and computer program product regarding techniques for quantifying flood risks associated with the properties.

2. Description of the Related Art

The “background” description provided herein is for the purpose of generally presenting the context of the disclosure. Work of the presently named inventors, to the extent it is described in this background section, as well as aspects of the description that may not otherwise qualify as prior art at the time of filing, are neither expressly nor implicitly admitted as prior art with respect to the present invention.

Worldwide, floods may be the number one cause of losses from natural events. Flood risk may be a function of flood hazards (e.g., hurricanes and/or damage to a levee or dam), property exposure to these hazards, and/or the damage vulnerability of properties during a flood. Comprehensive flood risk assessment (and scoring) and flood loss mitigation planning may need to address these three aspects. In addition, some flood planners may consider alternatives for coping with flood hazards including land-use planning, upstream watershed treatment, flood-proofing buildings, insurance and reinsurance measures, emergency evacuation, and building levees/dams and other structures.

In the United States, floods may account for significant property and business interruption losses affecting thousands of enterprises each year, which may cost more in property damages than other natural disasters. In 2005, the flooding from Hurricane Katrina alone caused over $40 billion in property damage, led to over 1600 deaths, and affected over 250,000 businesses according to the United States Census Bureau. Among federal, public, and private measures on flood loss mitigation, insurance and reinsurance may be a key factor in reducing the financial risk to individuals, enterprises and even whole societies. Mortgage companies, public sector (from the Federal Emergency Management Agency (FEMA) to municipalities), capital markets, insurance, and reinsurance companies may need knowledge about frequencies of floods, flood elevations, and frequencies of flood inundation losses at different property locations in order to make certain business decisions, such as to underwrite sufficient and comprehensive policies for these properties.

Traditionally flood risk for both residential and commercial properties may have been determined by whether the properties were inside or outside FEMA special flood hazard areas (SFHAs). Whether the property is inside or outside of an SFHA may have been the principle risk factor considered in determining whether to purchase flood insurance. Flood risks associated with properties within and beyond SFHAs may be different. In an SFHA, properties located near flood sources with lower elevations may have a higher flood risk than properties near SFHA boundaries at a higher elevation. Repetitive loss may occur more often in properties at lower elevations because the flood frequencies at lower elevations may be much higher. Beyond the “100 year flood zone”, properties may also suffer flood damage. For example, based on FEMA records, 30% of claims were from the outside of “100 year flood zones”.

### SUMMARY

As recognized by the present inventors, the accuracy of hazard risk assessment is highly dependent upon the ability to precisely identify locations of properties or building structures within particular parcels. Theoretically, the primary focus of such risk assessment is not the total land area of the properties, but the specific location or structure locations (improvements) that would incur damage from natural disasters. Street segment interpolation-based geocoding technology has been used to provide the locations of property based on the distance extrapolation using the address ranges along street line segments. However, street line segments and properties are in different geospatial entities with different design targets and objectives. Since properties are not evenly distributed along street line segments, often, the geocodes from the street segment based geocoding technology do not accurately identify the physical location of the properties. The present assignee, has progressively developed parcel based geocoding technology that more accurately identifies the location of land associated with the properties. The parcel based geocoding technology has significantly increased geocoding accuracy in comparison to street segment extrapolation.

However, as recognized by the present inventors, even with the enhanced accuracy of parcel based geocoding, using the parcel centroid of a property for assessing flood risk for structures on that property, in some instances, may need further adjustment in order to provide quality hazard risk analysis. On a small residential lot there is a high likelihood that the parcel centroid will coincide with the structure, thereby placing the geocode location precisely on the residence. However, for larger properties, including commercial parcels that occupy multiple acres, the parcel centroid may not coincide with the structures.

In view of the limitations with conventional systems, the present inventors identified a mobile computer device-based approach that uses available GPS-based position information to record particular locations within a property, such as building feature-locations within a particular parcel. These feature locations may then be correlated with particular flood risk regions (e.g., lake) so that not only is the centroid of the building properly placed within the parcel, but features of the building(s) have position and have been elevation mapped and risk-scored with respect to the potential flood risk hazard.

The foregoing paragraphs have been provided by way of general introduction, and are not intended to limit the scope of the following claims. The described embodiments, together with the further advantages, will be best understood by reference to the following detailed description taken in conjunction with the accompanying drawings.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a computer based system and network that may be employed for information exchange, processing capability and analysis, according to one embodiment;

FIG. 2 is a computer system that may be suitable for implementing various embodiments of a system and method for flood risk scoring according to the embodiment;

FIG. 3 is a front-view of an exemplary mobile tablet computer that may be employed to complement or as a substitute for the computer system of FIG. 2;

FIG. 4 is a back-view of the mobile tablet computer of FIG. 3;

FIG. 5 is a block diagram of selected components of the mobile tablet computer of FIG. 3;

FIG. 6 is a drawing that describes an embodiment of a method providing a flood risk assessment for a property point;

FIGS. 7 and 8 describe plots for a flood elevation point on an exemplary map used for flood risk assessment and scoring according to the embodiment;

FIG. 9 is a flowchart of a method for providing a flood risk assessment for a property point;

FIG. 10 is a flowchart of a method for assigning a flood risk score;

FIG. 11 illustrate various components for determining base flood elevation (BFE) and water surface elevation (WSE) according to an embodiment

FIGS. 12a and 12b illustrate equations and identifiers for calculating a flood risk score, according to an embodiment;

FIG. 13 is a flowchart of a general process for determining flood risk scores for different property locations on a parcel;

FIG. 14 is a flowchart for inputting and verifying structural attributes of a building structure on a particular parcel;

FIG. 15 is a flowchart of a process for inputting data for various structural position points of a structure on a parcel;

FIG. 16 is a process for generating a heat map for a particular parcel; and

FIG. 17 is an exemplary graphical user interface, used on a mobile computer-device for inputting data with regard to particular property locations on a parcel.

### DETAILED DESCRIPTION

The following describes various aspects of a system and method that collects relevant data regarding a property that that may be susceptible to damage from a natural hazard, such as a flood. For a particular property point, an assessment is made of the property point with respect to the hazard, and then a score (e.g., flood risk score, FRS) is assigned to that property point. Rather than merely assessing a parcel of land's susceptibility to the hazard from a centroid of the parcel, the present inventors recognized the benefits of assessing particular property points (e.g., a building or parts of a building) that would be the main cause of financial harm on that property if damaged by the hazard, such as a flood. Furthermore, the present inventors identified various approaches for identifying relevant property points that should be scored, when assessing the hazard risks for a particular parcel. Relevant property points may be features of a building structure on the subject property, the points being corners of the building for example. The relevant property points can be derived manually or from a process that analyzes imagery data (such as aerial data) that result in building footprints, which may be analyzed with respect to potential hazard areas, susceptible to flooding, for example.

The following description begins with a general discussion of how flood risk assessments may be scored for particular property points, followed by methodology and rationale for identifying relevant property points on a parcel to be analyzed. An additional description is provided for how a mobile computer device may be used to verify or enter relevant property features or how risk mitigation techniques associated with a property may be collected for refining the scoring analysis for a particular parcel.

Flood Risk Scoring Resources

Although a more detailed description is provided in U.S. patent application Ser. No. 12/027,096, a brief summary is provided herein for completeness. Flood risk scoring can be computed based on various means and through various embodiments, such as through the computation of a flood frequency versus flood elevation curve, or through the combination of primary and secondary flood risk factors. Examples of various embodiments are provided below, however these descriptions are provided as a general discussion of possible methodologies and are not intended to limit the mobile application of flood risk scoring assessment to these particular embodiments.

In various embodiments, a flood frequency versus flood elevation (flood depth) curve may be computed for a property point (e.g., a geocoded point location defined using geospatial coordinates, such as a latitude and a longitude, a georeferenced point (e.g., referenced to a coordinate system), an address, a building at an address, or other points of interest (POI)) in a flood risk area. Those curves may then be used to associate the point, the financial value of the structures associated with that point, to arrive at a FRS (e.g., 0 being no risk, 25 being moderate risk, and 50 being a high risk, for example). FRS is a helpful metric used for financial risk assessment for that particular property point.

In some embodiments, the flood frequency versus flood elevation curves may be determined for several property points in a portfolio. While FEMA is suggested as a possible source of flood maps herein, it is to be understood that the methods described herein may be used for property points worldwide (e.g., not constrained to the United States). For example, other flood map sources may be used to assist in analyzing property points located outside the United States. The flood frequency may refer to a flood level that has a specified percent chance of being equaled or exceeded in a given year. For example, a 100-year flood may occur on average once every 100 years and thus may have a 1 -percent chance of occurring in a given year. In some embodiments, the flood frequency may be in decimal format (e.g., 0.01 for the 100 year flood (0.01=1/100 years) or a maximum flood event occurring statistically once every 100 years, 0.002 for the 500 year flood (0.002=1/500 years) or a maximum flood event occurring statistically once every 500 years). In some embodiments, exceedance probability may be used instead of or in addition to flood frequency. Exceedance probability may refer to a probability of a value exceeding a specified magnitude in a given time period. For example, the data on a flood frequency curve may also be plotted as an exceedance probability curve. Other flood frequencies and flood frequency formats are also contemplated. Flood elevation may indicate an elevation of the surface of flood waters during the corresponding flood event. For example, if the flood water surface rises to an elevation of 180 m (e.g., above sea level) at a property point during a flood event occurring statistically once every 100 years, the 100 year flood elevation for the property point may be 180 m. Other flood elevation formats are also contemplated (e.g., the flood elevation may be represented as a flood depth of the flood waters above the ground surface (e.g., 10 feet above the ground surface), etc.).

Initial flood datasets may be provided by several sources. For example, datasets may be provided from flood maps such as digital flood zoning maps (for example, Digital Flood Insurance Rate Maps (DFIRM) (e.g., from the Federal Emergency Management Agency (FEMA)). Flood maps may include flood risk zoning maps adopted by communities that participate in the National Flood Insurance Program. Other flood maps are also contemplated. Flood maps may be stored in geospatial databases. Other sources of initial flood map datasets are also contemplated (e.g., datasets may originate from flood elevation lines or from flood elevation raster images). Additional data may be derived from 1-10 m Digital Elevation datasets (“1-10 m” may indicate a resolution of the maps), USGS (United States Geological Survey) gage station records, and flood source features from USGS National Hydrologic Datasets. Other resolution (e.g., higher resolution) digital elevation datasets are also contemplated. These initial datasets may only provide a single point at a flood frequency versus flood elevation curve for a given geographic location (e.g., a given property point) in a flood risk area (e.g., the 100-year base flood elevation). For example, these datasets may provide the flood elevation line for a 100-year (and/or 500-year) flood (100-year and 500-year refer to flood frequency) for a set of points. In some embodiments, the flood frequency versus flood elevation curve may be computed for geospatial points (e.g., property points) based on, for example, two statistically determined discrete points (such as 100-year and 500-year flood elevations) derived from a flood map (e.g., a digital flood risk boundary map), flood elevation lines for flood elevations, and digital elevation data. In some embodiments, the two points may not be statistically determined discrete points. Based on these determined points, flood frequency versus damage curves may be calculated to assist in flood risk assessment (e.g., to assist in insurance premium determinations for a property point). In some embodiments, prior to calculating the two points, missing data (e.g., missing flood elevation lines and/or flood boundaries) may be computed (e.g., using the methods described herein). In some embodiments, existing or derived flood elevation lines and/or flood boundaries may also be corrected (e.g., using the methods described herein).

Computer Resources

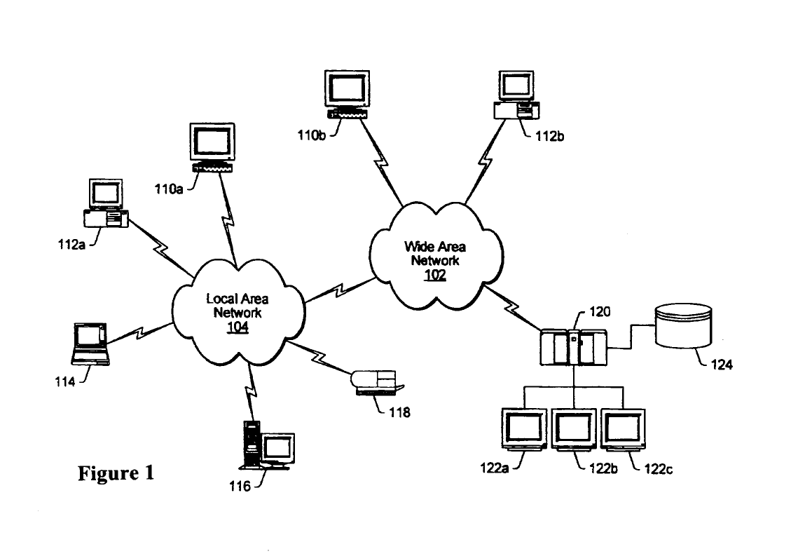

FIG. 1 illustrates an embodiment of a WAN 102 and a LAN 104. WAN 102 may be a network that spans a relatively large geographical area, and may optionally include cloud computing resources that host applications, and/or provide computing and storage resources as needed to supplement the processes and resources discussed herein. The Internet is an example of a WAN 102. WAN 102 typically includes a plurality of computer systems that may be interconnected through one or more networks. Although one particular configuration is shown in FIG. 1, WAN 102 may include a variety of heterogeneous computer systems and networks that may be interconnected in a variety of ways and that may run a variety of software applications.

One or more LANs 104 maybe coupled to WAN 102. LAN 104 may be a network that spans a relatively small area. Typically, LAN 104 may be confined to a single building or group of buildings. Each node (i.e., individual computer system or device) on LAN 104 may have its own CPU with which it may execute programs. Each node may also be able to access data and devices anywhere on LAN 104. LAN 104, thus, may allow many users to share devices (e.g., printers) and data stored on file servers. LAN 104 may be characterized by a variety of types of topology (i.e., the geometric arrangement of devices on the network), of protocols (i.e., the rules and encoding specifications for sending data, and whether the network uses a peer-to-peer or client/server architecture), and of media (e.g., twisted-pair wire, coaxial cables, fiber optic cables, and/or radio waves).

Each LAN 104 may include a plurality of interconnected computer systems and optionally one or more other devices. For example, LAN 104 may include one or more workstations 110a, one or more personal computers 112a, one or more laptop or notebook computer systems 114, one or more server computer systems 116, and one or more network printers 118. As illustrated in FIG. 1, an example LAN 104 may include one of each computer systems 110a, 112a, 114, and 116, and one printer 118. LAN 104 may be coupled to other computer systems and/or other devices and/or other LANs through WAN 102.

One or more mainframe computer systems 120 may be coupled to WAN 102. As shown, mainframe 120 may be coupled to a storage device or file server 124 and mainframe terminals 122a, 1226, and 122c. Mainframe terminals 122a, 122b, and 122c may access data stored in the storage device or file server 124 coupled to or included in mainframe computer system 120.

WAN 102 may also include computer systems connected to WAN 102 individually and not through LAN 104. For example, workstation 11 OA and personal computer 112b may be connected to WAN 102. For example, WAN 102 may include computer systems that may be geographically remote and connected to each other through the Internet.

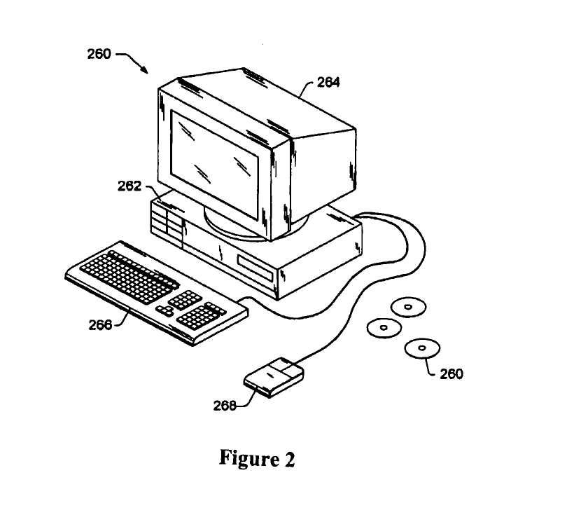

FIG. 2 illustrates an embodiment of computer system 250 that may be suitable for implementing various embodiments of a system and method for flood risk assessment. Each computer system 250 typically includes components such as CPU 252 with an associated memory medium such as CD-ROMs 260. The memory medium may store program instructions for computer programs. The program instructions may be executable by CPU 252. Computer system 250 may further include a display device such as monitor 254, an alphanumeric input device such as keyboard 256, and a directional input device such as mouse 258. Computer system 250 may be operable to execute the computer programs to implement computer-implemented systems and methods for flood risk assessment.

Computer system 250 may include a memory medium on which computer programs according to various embodiments may be stored. The term “memory medium” is intended to include an installation medium, e.g., floppy disks or CDROMs 260, a computer system memory such as DRAM, SRAM, EDO RAM, Rambus RAM, etc., or a non-volatile memory such as a magnetic media, e.g., a hard drive or optical storage. The memory medium may also include other types of memory or combinations thereof. In addition, the memory medium may be located in a first computer, which executes the programs or may be located in a second different computer, which connects to the first computer over a network. In the latter instance, the second computer may provide the program instructions to the first computer for execution. Computer system 250 may take various forms such as a personal computer system, tablet computer, smartphone (e.g, IPHONE, with associated APPS), mainframe computer system, workstation, network appliance, Internet appliance, personal digital assistant (“PDA”), television system or other device. In general, the term “computer system” may refer to any device having a processor that executes instructions from a memory medium (non-transitory computer readable storage device).

The memory medium may store a software program, such as an APP, or programs operable to implement a method for flood risk assessment. The software program(s) may be implemented in various ways, including, but not limited to, procedure-based techniques, component-based techniques, and/or object-oriented techniques, among others. For example, the software programs may be implemented using ActiveX controls, C++ objects, JavaBeans, Microsoft Foundation Classes (“MFC”), browser-based applications (e.g., Java applets), APPs like those available from APPLE COMPUTER's APP STORE, traditional programs, or other technologies or methodologies, as desired. A CPU such as host CPU 252 executing code and data from the memory medium may include a means for creating and executing the software program or programs according to the embodiments described herein.

Various embodiments may also include receiving or storing instructions and/or data implemented in accordance with the foregoing description upon a carrier medium. Suitable carrier media may include storage media or memory media such as magnetic or optical media, e.g., disk or CD-ROM, as well as signals such as electrical, electromagnetic, or digital signals, may be conveyed via a communication medium such as a network and/or a wireless link.

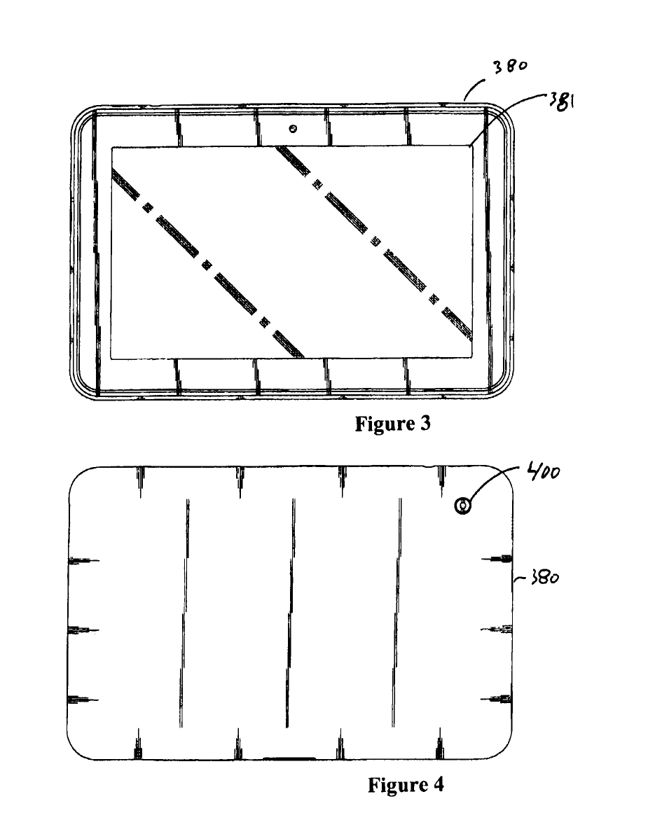

FIG. 3 is a front view of a tablet computer 380 having a touch screen 381. The tablet computer 380 is a mobile device that allows individuals to provide input through the touch panel 381 and also receive a displayed result. As will be discussed in future embodiments, the mobile tablet computer 380 is one example of a mobile device, others being smart phones, laptop computers, etc., that allow an operator to execute either locally or remotely (perhaps through a cloud computing service) applications that assist the user in recording data regarding particular property. For example the GPS (Global Positioning System) feature in the tablet computer 380 enables the user to walk to particular locations on a parcel, perhaps near each corner of a building, and record the latitude, longitude and elevation (either directly from the GPS module in the tablet computer or through an associated APP, such as CURRENT ELEVATION) at that location, which may then be associated with the footprint of the structure to which later flood risk scores may be associated.

FIG. 4 is a backside view of the tablet computer 380. The backside includes a camera 400. Alternatively, the camera may be included on the front of the tablet computer 380. The camera may either be a digital still camera, and/or a video camera.

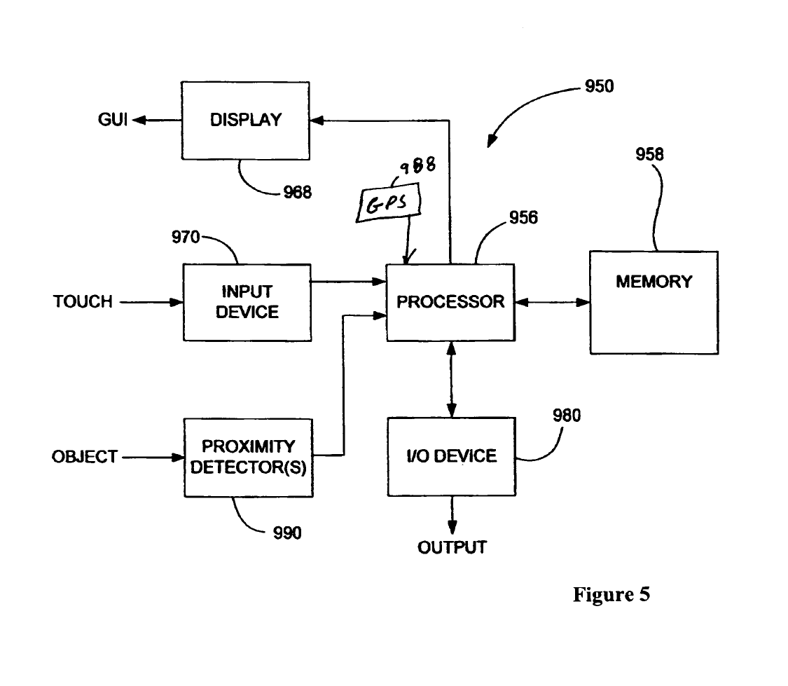

FIG. 5 is a block diagram of an exemplary computer system 950, in accordance with one embodiment of the present invention. The computer system 950 may correspond to a personal computer, such as a desktop, laptop, tablet or handheld computer. The computer system may also correspond to other types of computing devices such as cell phones, PDAs, media players, consumer electronic devices, and/or the like.

The exemplary computer system 950 shown in FIG. 5 includes a processor 956 configured to execute instructions and to carry out operations associated with the computer system 950. For example, using instructions retrieved for example from memory, the processor 956 may control the reception and manipulation of input and output data between components of the computing system 950. The processor 956 can be implemented on a single-chip, multiple chips or multiple electrical components. For example, various architectures can be used for the processor 956, including dedicated or embedded processor, single purpose processor, controller, ASIC, and so forth.

In most cases, the processor 956 together with an operating system operates to execute computer code and produce and use data. By way of example, the operating system may correspond to Mac OS, OS/2, DOS, Unix, Linux, Palm OS, and the like. The operating system can also be a special purpose operating system, such as may be used for limited purpose appliance-type computing devices. The operating system, other computer code and data may reside within a memory block 958 that is operatively coupled to the processor 656. Memory block 958 generally provides a place to store computer code and data that are used by the computer system 950. By way of example, the memory block 958 may include Read-Only Memory (ROM), Random-Access Memory (RAM), hard disk drive and/or the like. The information could also reside on a removable storage medium and loaded or installed onto the computer system 950 when needed. Removable storage media include, for example, CD-ROM, PC-CARD, memory card, floppy disk, magnetic tape, and a network component.

The computer system 950 also includes a display device 968 that is operatively coupled to the processor 956. The display device 968 may be a liquid crystal display (LCD) (e.g., active matrix, passive matrix and the like) with a touchscreen capability. Alternatively, the display device 968 may be a monitor such as a monochrome display, color graphics adapter (CGA) display, enhanced graphics adapter (EGA) display, variable-graphics-array (VGA) display, super VGA display, cathode ray tube (CRT), and the like. The display device may also correspond to a plasma display or a display implemented with electronic inks or OLEDs.

The display device 968 is generally configured to display a graphical user interface (GUI) that provides an easy to use interface between a user of the computer system and the operating system or application running thereon. Generally speaking, the GUI represents programs, files and operational options with graphical images. The graphical images may include windows, fields, dialog boxes, menus, icons, buttons, cursors, scroll bars, etc. Such images may be arranged in predefined layouts, or may be created dynamically to serve the specific actions being taken by a user. During operation, the user can select and activate various graphical images in order to initiate functions and tasks associated therewith. By way of example, a user may select a button that opens, closes, minimizes, or maximizes a window, or an icon that launches a particular program. The GUI can additionally or alternatively display information, such as non interactive text and graphics, for the user on the display device 968.

The computer system 950 also includes an input device 970 that is operatively coupled to the processor 956. The input device 970 is configured to transfer data from the outside world into the computer system 950. The input device 970 may include a touch sensing device configured to receive input from a user's touch and to send this information to the processor 956. In many cases, the touch-sensing device recognizes touches, as well as the position and magnitude of touches on a touch sensitive surface. The touch sensing means reports the touches to the processor 956 and the processor 956 interprets the touches in accordance with its programming. For example, the processor 956 may initiate a task in accordance with a particular touch. A dedicated processor can be used to process touches locally and reduce demand for the main processor of the computer system. The touch sensing device may be based on sensing technologies including but not limited to capacitive sensing, resistive sensing, surface acoustic wave sensing, pressure sensing, optical sensing, and/or the like. Furthermore, the touch sensing means may be based on single point sensing or multipoint sensing. Single point sensing is capable of only distinguishing a single touch, while multipoint sensing is capable of distinguishing multiple touches that occur at the same time.

In the illustrated embodiment, the input device 970 is a touch screen that is positioned over or in front of the display 968. The touch screen 381 (also the input device 970) may be integrated with the display device 968 or it may be a separate component. The touch screen 381 has several advantages over other input technologies such as touchpads, mice, etc. For one, the touch screen 970 is positioned in front of the display 968 and therefore the user can manipulate the GUI directly. For example, the user can simply place their finger over an object to be selected, activated, controlled, etc. In touch pads, there is no one-to-one relationship such as this. With touchpads, the touchpad is placed away from the display typically in a different plane. For example, the display is typically located in a vertical plane and the touchpad is typically located in a horizontal plane. This makes its use less intuitive, and therefore more difficult when compared to touch screens.

The touchscreen 970 can be a single point or multipoint touchscreen. Multipoint input devices have advantages over conventional single point devices in that they can distinguish more than one object (finger) simultaneously. Single point devices are simply incapable of distinguishing multiple objects at the same time.

The computer system 950 also includes a proximity detection system 990 that is operatively coupled to the processor 956. The proximity detection system 990 is configured to detect when a finger (or stylus) is in close proximity to (but not in contact with) some component of the computer system including for example housing or I/O devices such as the display and touch screen. The proximity detection system 990 may be widely varied. For example, it may be based on sensing technologies including capacitive, electric field, inductive, hall effect, reed, eddy current, magneto resistive, optical shadow, optical visual light, optical IR, optical color recognition, ultrasonic, acoustic emission, radar, heat, sonar, conductive or resistive and the like. A few of these technologies will now be briefly described.

The computer system 950 also includes capabilities for coupling to one or more I/O devices 980. By way of example, the I/O devices 980 may correspond to keyboards, printers, scanners, cameras, speakers, and/or the like. The I/O devices 980 may be integrated with the computer system 950 or they may be separate components (e.g., peripheral devices). In some cases, the I/O devices 980 may be connected to the computer system 950 through wired connections (e.g., cables/ports). In other cases, the I/O devices 980 may be connected to the computer system 950 through wireless connections. By way of example, the data link may correspond to PS/2, USB, IR, RF, Bluetooth or the like.

In addition, the computer system 950 includes a GPS module 988 (sometimes referred to as a positioning module) that communicates with the processor 956. The GPS 988 not only collects position information (latitude, longitude and elevation), but records this information at specific position points. For example, the position information is recorded when a user makes a position point recording request when investigating a particular property. The user may choose to record position points (sometimes referred to as property points) at the corners of the building on a parcel, or perhaps continuously records the position information as the user walks around the periphery of the building structure. Position information is then recorded in the memory 958, which may be stored locally if the application software is executed locally, or output through the I/O device 980 for processing at a remote site, such as through a dedicated server, or perhaps through a remote computer system such as in a cloud computing context.

Flood Risk Scoring Overview

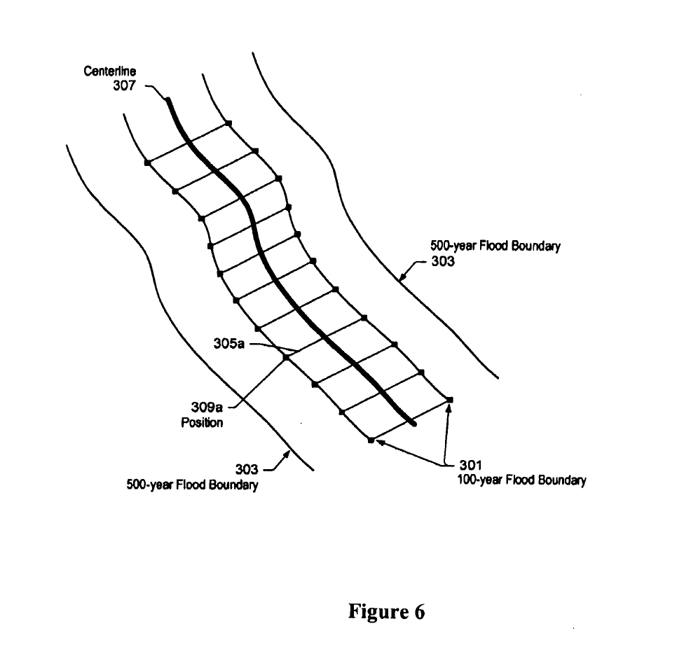

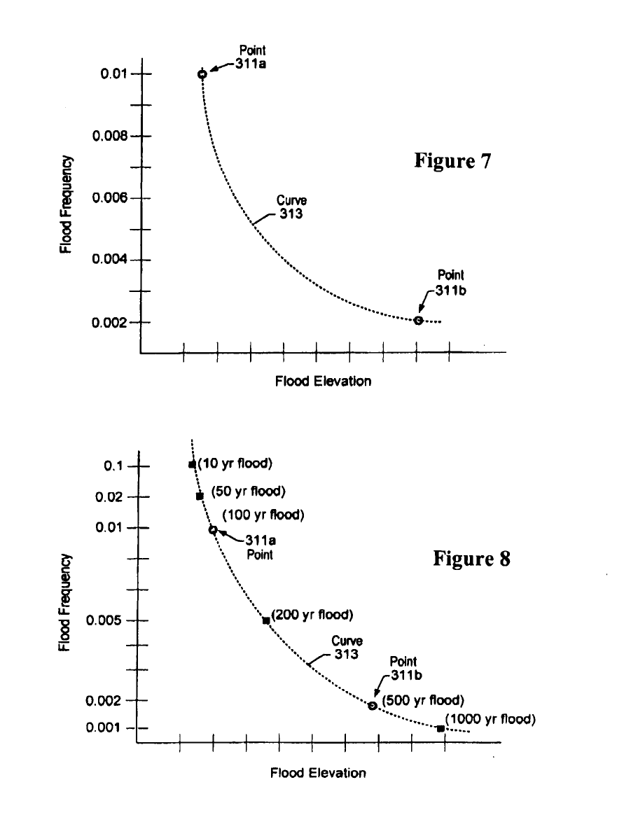

FIGS. 6, 7, and 8 illustrate an embodiment of an example flood map and plotted curves of a flood elevation versus flood frequency points on the example flood map, which allows for the assessment of a flood risk at a particular property point. As seen in FIG. 6, flood elevation lines 305 (e.g., base flood elevation (BFE) line 305a) may be provided for a position (e.g., position 309a corresponding to a property point) on the 100-year flood boundary 301 from a flood source line feature (for example, a waterway centerline 307 (e.g., a river centerline)). For example, plot point 311a (see FIGS. 7 and 8) may represent the flood elevation for position 309a for the 0.01 flood frequency (100-year flood frequency). To build a curve for flood frequency versus flood elevation for a position (e.g., position 309a), a second point 311b (e.g., for the 0.002 flood frequency (at the 500-year flood boundary 303)) on the curve 313 may be needed (several embodiments for determining the first point 311a and/or second point 311b are described herein). For example, if second point 311b is known or calculated, the curve 313 for flood frequency versus flood elevation may be calculated, using a curve fitting algorithm, for position 309a that may show other flood frequency versus flood elevations for position 309a (several embodiments for calculating the curve 313 are also described herein). FIG. 8 also shows other points on the flood frequency versus flood elevation curve 313 (with modified axis to show additional flood frequencies versus flood elevations).

As defined by the National Flood Insurance Program (NFIP), base flood elevation (BFE) is “the elevation shown on the Flood Insurance Rate Map for Zones AE, AH, A1-A30 V1-V30 and VE that indicates the water surface elevation resulting from a flood that has a one percent chance of equaling or exceeding that level in any given year.” The BFE is the elevation of the water projected to occur in association with the base flood, which by definition is a “flood having a one percent chance of being equaled or exceeded in any given year” see 44 C.F.R. 59.1. As used herein “flood elevations” and “flood elevation lines” are used to refer to the elevation of floods and lines representing these elevations for various flood frequencies (e.g., 500-year flood). “Flood elevation line” for the 100-year flood frequency may be used interchangeably with the term “BFE”.

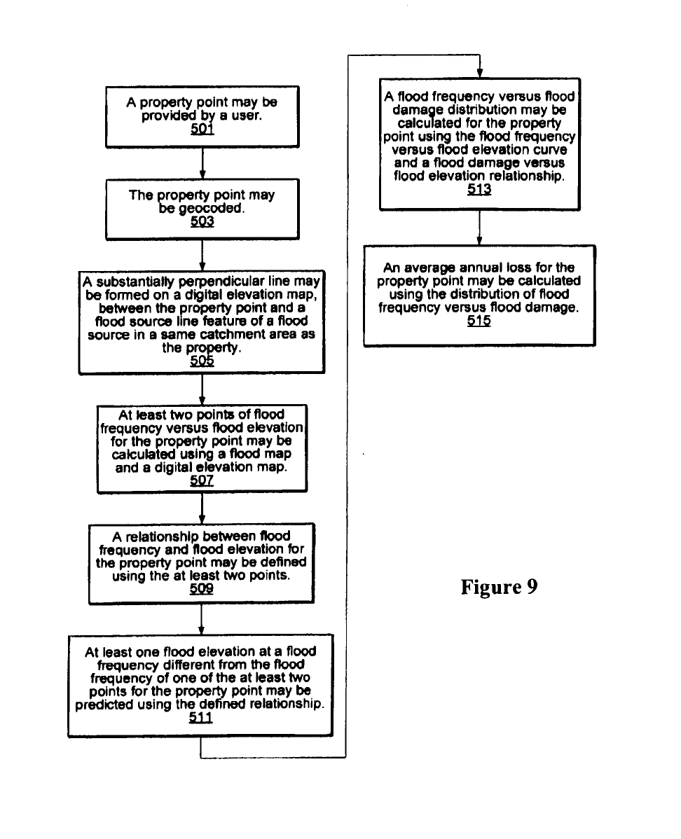

FIG. 9 illustrates an embodiment of a method for providing a flood elevation and flood risk assessment for a property point. It should be noted that in various embodiments of the methods described below, one or more of the elements described may be performed concurrently, in a different order than shown, or may be omitted entirely. Other additional elements may also be performed as desired.

At 501, a property point may be provided by a user (e.g., the address of a targeted portfolio from a mortgage company, public sector entity (e.g., FEMA, municipalities, states, etc.), capital market entity, insurance company, or reinsurance company), or even the lat/long of a GPS recorded position provided by an appraiser or home inspector.

At 503, the property point may be geocoded (e.g., an x,y coordinate (such as a latitude/longitude) may be determined by the system) if it is not already recorded.

At 505, a substantially perpendicular line may be formed on a digital elevation map, between the property point and a flood source line feature of a flood source in a same catchment area as the property. The substantially perpendicular line may be used to associate the property point with the flood source line feature and one or more flood boundaries. The perpendicular line may also be formed as a cross section through the property point (e.g., in three dimensional space). Other uses of the perpendicular line/cross section are also contemplated. Using the mobile device such as the table computer (FIG. 3) the flood source location, and/or a bearing angle from the property point to the potential flood source.

At 507, at least two points of flood frequency versus flood elevation for the property point may be calculated using a flood map and a digital elevation map. As described herein, calculating the at least two points may include statistically determining the at least two flood frequency versus flood elevation points. For example, the 100-year flood elevation and the 500-year flood elevations may be determined for the property point (e.g., according to flood elevation lines, corresponding to flood frequency boundaries, crossing through the property point). In some embodiments, other flood elevations may be determined for the property point in addition to or instead of the 100-year base flood elevation and the 500-year flood elevation. Flood maps may include maps of flood zones (defined by flood boundaries) and a plurality of pre-existing flood elevation lines. For example, FEMA Flood Insurance Rate Maps may have 100-year flood elevation lines printed on them for some areas. In some embodiments, FEMA maps may have the 500-year flood boundary printed on them for some areas, but may not have 500-year flood elevation lines printed on them. In some embodiments, the 100-year and/or 500-year flood elevation lines may be determined or provided from other flood map sources (e.g., a FEMA Flood Insurance Study (FIS)). Digital elevation maps may include digital elevation models and/or digital elevation datasets. Other maps and datasets may also be used for elevation.

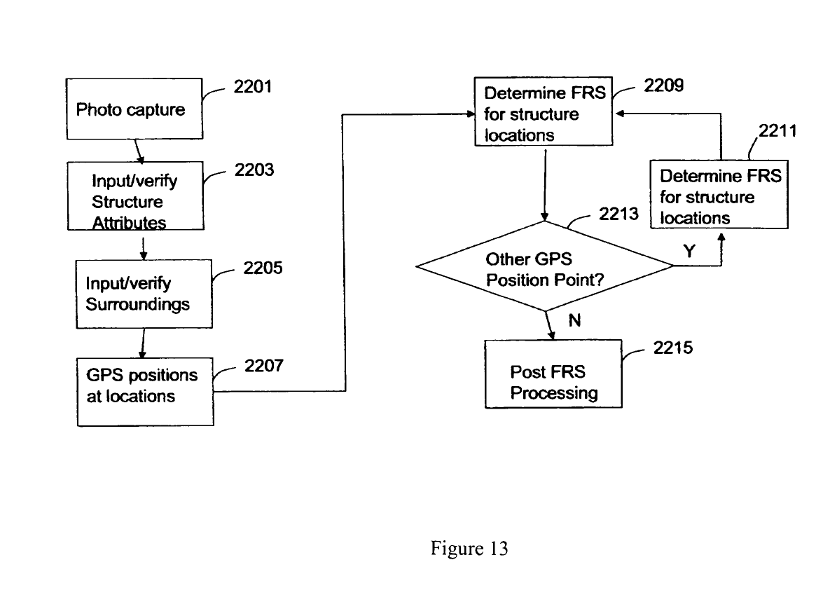

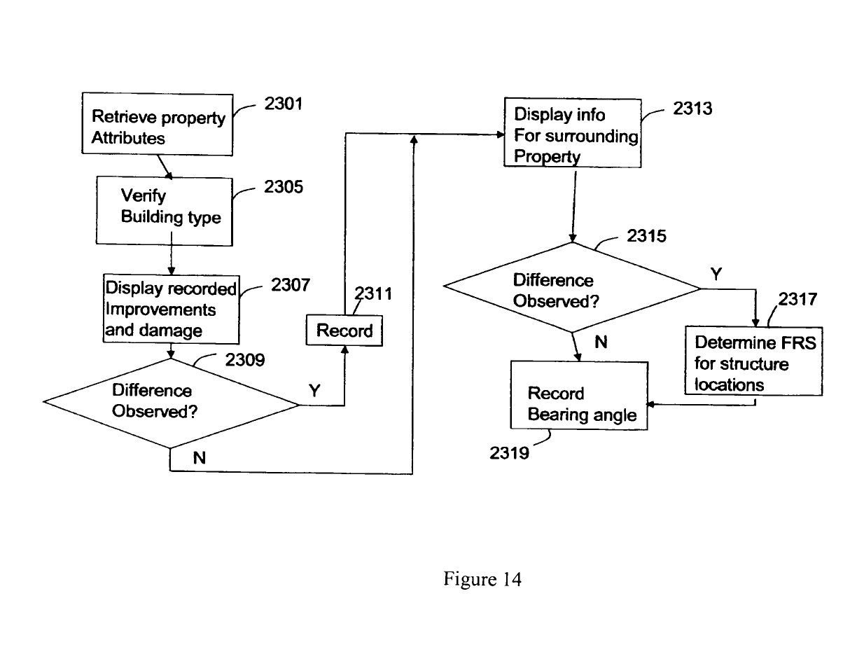

The predetermined flood elevations may be stored in 100-year and 500-year flood elevation layers. These layers may then be queried after the property point request is received. In some embodiments, the 100-year and 500-year flood elevations may be determined during runtime (e.g., after the property point request is received) using the process designated in U.S. Pat. No. 7,917,292. Determining the 100-year and 500-year flood elevation lines may be automated or may be manual. Again, while several examples are provided using the 100-year and 500-year flood elevations, it is to be understood that other flood elevations may be used instead. Other methods are also contemplated and described herein. For example, at least two points of flood frequency versus flood elevation for the property point may be determined at the intersection of a cross section, through the property point, and flood frequency surfaces (e.g., the 100 year flood surface and the 500 year flood surface) (e.g., see FIGS. 36a-b of U.S. Pat. No. 7,917,292). As another example, corresponding flood elevations for flood frequencies may be determined at an intersection of a line (through the property point and substantially perpendicular to a flood source line feature) and the corresponding flood boundaries (e.g., see FIGS. 13-14 of U.S. Pat. No. 7,917,292). As yet another example, the at least two points of flood frequency versus flood elevation for the property point may be calculated using cross section data on a flood profile (e.g., see FIG. 37 of U.S. Pat. No. 7,917,292). Other methods are also contemplated, such as the systems and methods described in U.S. patent application Ser. No. 12/027,096.

At 509, a relationship between flood frequency and flood elevation for the property point may be defined using the at least two points. For example, a flood frequency versus flood elevation curve may be determined at the property point. Using the 100-year and 500-year flood elevation points, a distribution may be calculated. The distribution may provide the flood elevation at other flood frequencies (e.g., 10 year, 50 year, 1000 year, etc.). For example, the distribution may be a logarithmic relationship. One logarithmic relationship that may be used is: Flood Elevation=a Log(flood return period)+b where flood return period=1/flood frequency and where a and b are defined by solving the equation for the at least two calculated points of flood frequency versus flood elevation. To develop this linear relationship, several data sets for different areas were analyzed. Other logarithmic relationships are also contemplated.

At 511, at least one flood elevation at a flood frequency different from the flood frequency of one of the at least two points for the property point may be predicted using the defined relationship. For example, if the relationship is represented as a curve, a flood elevation at a corresponding flood frequency may be determined from the curve. If the relationship is defined as an equation, a flood elevation for a corresponding flood frequency may be determined using the defined equation. Other relationships are also contemplated.

At 513, a flood frequency versus flood damage distribution may be calculated for the property point using the flood frequency versus flood elevation curve and a flood damage versus flood elevation relationship (e.g., a vulnerability curve provided by the user). Additional data may also be used (e.g., provided by the user about the property point).

At 515, an average annual loss for the property point may be calculated using the distribution of flood frequency versus flood damage (e.g., by interpolation). In some embodiments, information may be used to provide a flood risk assessment report to the user. In some embodiments, a flood elevation versus percent damage relationship may be defined (e.g., using one or more flood studies for the property area) and the average annual loss for the property point may be determined using the flood elevation versus percent damage relationship.

Different probability distributions may be used to calculate the curve 313 with two or more points 311a and 311b (which may be statistically determined flood elevation points). For example, the Log Pearson Type III distribution, the Log Normal distribution, and/or the Extreme Value Type I distribution may be used. Other distributions may also be used. The magnitude of a flood event (flood elevation) and the corresponding flood frequency may have a non-linear relationship. The flood elevation in the relationship may change more significantly during smaller flood frequencies (e.g., 5, 10-year return periods) than longer flood frequencies (e.g., 500 year return periods). In some embodiments, the relationship between flood elevations and flood frequency in a range of flood frequency between approximately 50 years to 1000 years may be near-linear after applying a logarithm transform on the flood frequency base. In some embodiments, a logarithm relationship between flood elevation and flood frequency may be defined at a cross section through the property point (and perpendicular to the flood source line feature) as: Flood Elevation=a Log(flood return period)+b In this relationship “a” may be the slope and “b” may be a constant that may be determined by solving the relationship with two flood elevation/flood frequency point pairs. A more detailed description of the mathematical analysis performed in the flood risk assessment is found in U.S. Pat. No. 7,917,292.

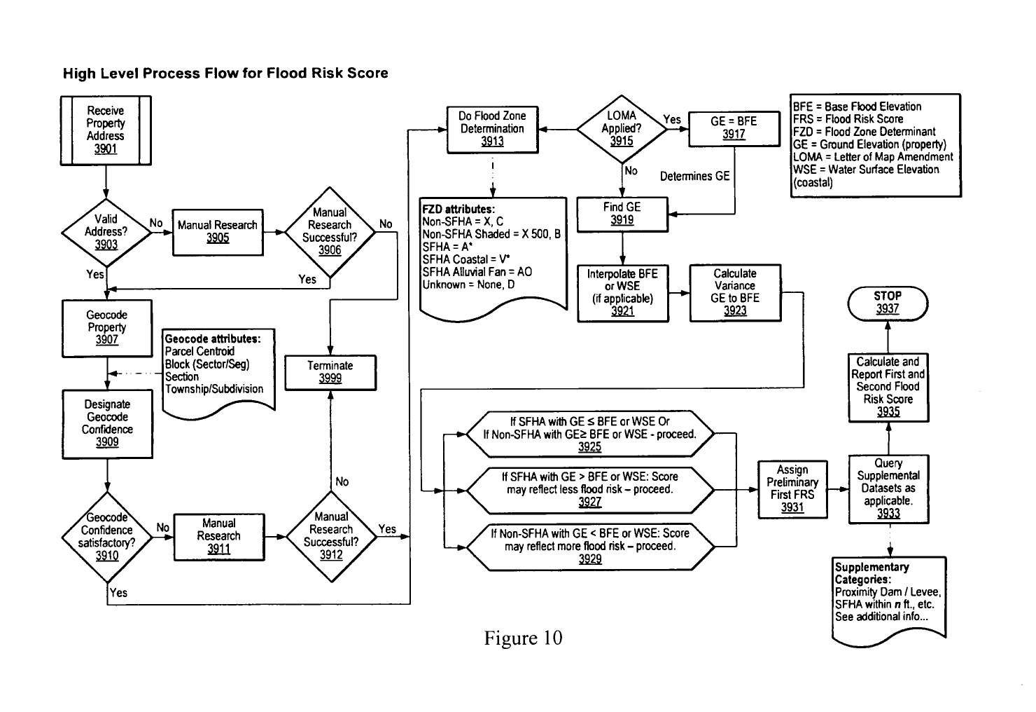

FIG. 10 illustrates a flowchart of an embodiment of a method for assigning a flood risk score. It should be noted that in various embodiments of the methods described below, one or more of the elements described may be performed concurrently, in a different order than shown, or may be omitted entirely. Other additional elements may also be performed as desired. In some embodiments, a portion or the entire method may be performed automatically by a computer system.

At 3901, a property point may be received (e.g., a property address may be received) at a flood risk score engine. The property point may be submitted, for example, as an address or latitude/longitude pair. The address may be received from, for example, an insurance carrier interested in a flood risk score for the property point. In some embodiments, the address may be entered into a web site or submitted over the phone by a flood risk score requester or other system user. Other methods for receiving the property point are also contemplated. For example, a spreadsheet of several addresses for flood risk score determinations may be received. Submissions to a website may be received by the flood risk score engine through eXtensible Markup Language (XML) (other formats are also possible). In some embodiments, various user submission interfaces (e.g., with a graphical user interface (GUI)) may be used for receiving the property points.

At 3903, a determination may be made as to whether the property point (e.g., address) provided is a valid property point. For example, the address may be compared against addresses in a look-up table of addresses.

If the address is determined not to be valid, at 3905, manual research may be performed (e.g., for the provider of the address) to determine a more accurate property point identifier. Manual research may include examining a map region and selecting a specific address point (e.g., by a human user). Other manual research may also be performed to determine a valid (e.g., more accurate) address. At 3906, a determination may be made as to whether the manual research was successful (e.g., whether a valid address was determined for the property address). If the manual research was not successful, the flow may terminate at 3999.

In some embodiments, footprints determined from either feature extraction software or manually predetermined rooftop points may be built. In some embodiments, software may be used to recognize certain features (e.g. structure rooftop outlines (footprints), roads, etc.) within, for example, aerial/satellite imagery. The software may be used to identify the location of buildings within parcel boundaries. This may provide accurate, automated structure-level flood zone determinations (e.g., which may be more accurate than using an identified parcel centroid). Human users may also identify and save, for example, rooftop points on aerial/satellite photos. These points may be used to identify, for example, a specific location of a house on the property point. In some embodiments, the flood risk score may be determined with respect to the specific location of the house (or other structure) on the property point. In some embodiments, a rooftop level, address level, and/or property level may be used as primary levels of geocoding for determining the flood risk score (other levels are also contemplated).

If the property point has a satisfactory geocode confidence (from 3910 or 3912), at 3913, a flood zone determination may be performed for the property point. The flood zone determination may include determining an applicable flood zone for the property point (e.g., using Flood Insurance Rate Maps (FIRMs), Digital FIRMs (DFIRMs), or other sources of flood map information). In some embodiments, a collection of flood maps from FEMA and/or DFIRMs spanning a geographical area (e.g., large portions of the United States) and/or internally generated maps may be used to determine the flood zone for the property point. FEMA may issue flood maps and flood map revisions on a periodic basis. Flood zones identified by FEMA on these maps may include: A, AO, A1-A30, AE, AR, AR/AO, AR/A1-A30, AR/AE, AR/AH, AR/A99, A99, AH, VO, V1-V30, VE, V, M, E, X, B, C, D, and None. Flood zones beginning with the letters A or V may be considered SFHAs, or high risk flood zones, with A-lettered zones being subject to riverine, lake overflow, ponding, or sheetflow flooding and V-lettered zones being subject to wave velocity flooding. As used herein, “A*” is used to refer to various possible “A” zones, “V*” is used to refer to various possible “V” zones, etc. However, the absence of an “*” does not necessarily indicate, for example, an A or V zone, exclusively. Zone M may designate mudslide prone areas and Zone E may designate erosion prone areas; both of which may also be considered SFHAs. Flood zones beginning with the letters B, C, and X may designate areas which are not SFHAs, are outside of the high risk flood zone, but may still be subject to a moderate (e.g., “500-year” flood zone, or less than 1 foot depth in a “100-year” flood zone) (shaded Zone X or Zone B) or low (e.g., outside of the “500-year” flood zone) (unshaded Zone X or Zone C) flood risk. Zone D may be used for areas that have not received a flood hazard evaluation, but may be subject to flooding. Zones B, C, X and D may not be considered SFHAs. These flood maps may be improved using aircraft implemented lasers to determine respective elevations upon which the flood zones may be more accurately identified.

In some embodiments, a flood zone determination for the property point may include grouping the property point into one of several (e.g., 6) flood zone determination groups for the purposes of determining a flood risk score. Other numbers of groups are also contemplated. The groups may include, for example, “Non-SFHA” if the property point is in zones X or C; “Non-SFHA Shaded” for zones X500 and B; “SFHA” for zone A (except SFHA Alluvial Fan), “SFHA Coastal” for zone V; “SFHA Alluvial Fan” for zones AO (AO may also include other types of SFHAs that are not alluvial fan); and “Unknown” for zones D and none. Other group divisions and designations are also contemplated.

At 3915, a determination may be made as to whether a Letter of Map Amendment (LOMA) has been applied or is available for a region with the property point. If a LOMA is available, at 3917, a GE for the property point may be considered to be the same as the nearest base flood elevation (BFE) (or, for example, an interpolated BFE for a calculated point such as a calculated point on a known flood risk zone boundary or a point on a known flood risk zone boundary at the associated cross-section 4013). This may provide a conservative estimate that may assist in automating a flood risk score assessment. In some embodiments, a LOMA elevation variance may be retrieved as a binary file (e.g., a PDF file). Determining the actual LOMA elevation variance (i.e., the actual elevation difference between the property point elevation and the elevation of the calculated point on a known flood risk zone boundary (such as a point on the known flood risk zone boundary)) for the property point may require manual interaction. For example, if BFE is equal to 904.2 feet and a lowest adjacent grade elevation (which may be the lowest grade elevation point around a building on the property point) is equal to 906.1 feet, then the elevation variance may equal +1.9 feet. In some embodiments, “lowest adjacent grade elevation” may be another way of determining a GE. In some embodiments, LOMAs may be determined by examining a letter of map change (LOMC) database. In some embodiments, the GE may be considered to be the same as the water surface elevation (WSE) of the calculated point on the nearest flood zone boundary if a LOMA is applicable to the property point. In other words, the property point may be considered to be outside of the 100 year flood zone. In some embodiments, a flood risk characteristic may include information from the LOMA for the property point such as validated information of flood risk changes on the flood zoning map. If a property has a LOMA, its flood risk score may be given a lower (or higher) ceiling/floor (e.g., 600) to indicate a lower level of flood risk even though the property is, for example, in an SFHA.

In some embodiments, regularly updated national FEMA DFIRM datasets may be incorporated in the flood maps used to calculate the flood risk score. In some embodiments, a LOMA and/or LOMR (letter of map revision) may also be referred to for information on property points to use in determining a flood risk score.

At 3919, the GE of the property point may be determined. In some embodiments, the United States Geological Survey (USGS) Elevation dataset with a 10 m/30 m resolution or higher resolution elevation datasets (e.g., from commercial companies) may be used in the GE determination. Other data sources may also be used (e.g., a more accurate data source (e.g., commercial) may be used). In some embodiments, an elevation map may be used to determine the GE. For example, the property point may be assigned an elevation as its GE that is the average of the four elevations of the corners of the square of the grid that the property point occupies on a digital elevation map. In some embodiments, a flood risk score requester may provide an elevation to use for the property point. In some embodiments, a database of elevation certificates may be accessed for an elevation certificate for the property point that has the elevation of the property. These elevation certificates may have highly accurate elevation data for their respective property. Elevation certificates may also be available for other locations. Other methods for determining a property point's GE are also contemplated. Other digital maps may include aircraft implemented laser determined elevations determined by aircraft using lasers to determine elevation for various points (such as Laser Imaging Detection and Ranging (LIDAR)).

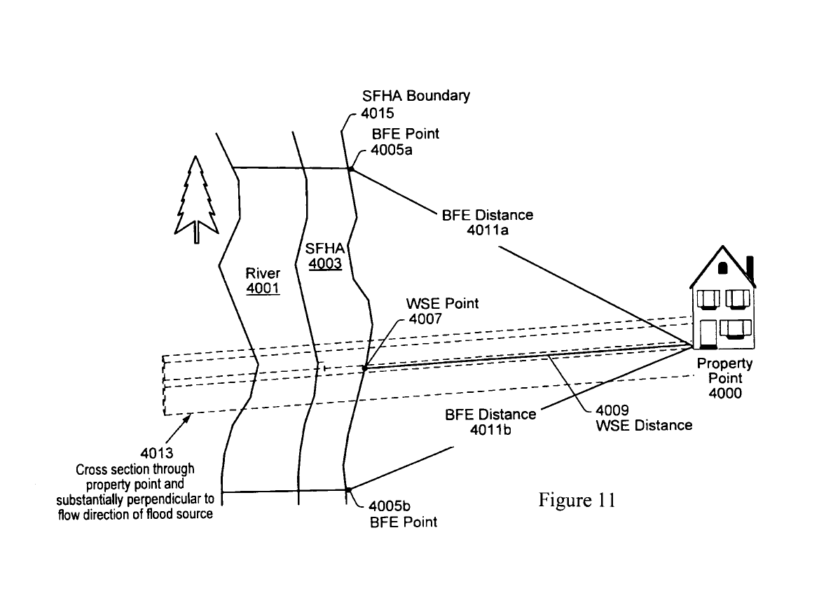

At 3921, a BFE or a WSE may be estimated for the property point. For example, the BFE or WSE of a calculated point such as a calculated point on a known flood risk zone boundary or a point on a known flood risk zone boundary at the associated cross-section 4013 may be determined. In some embodiments, a cross-section (e.g., see FIG. 11), a radius search method, a water drop method (e.g., see FIGS. 57-59 of application Ser. No. 12/027,096), and/or surface method (e.g., see FIGS. 55-56 of application Ser. No. 12/027,096) may be used to determine the associated BFE or WSE (e.g., of the calculated point hydrologically and hydraulically associated with the property point).

In some embodiments, a radius search method (e.g., nearest point method) may be used to determine an associated BFE or WSE. For example, the BFE or WSE may be determined using a geospatial search functionality that uses a dynamic buffer to search a nearest polygon or line feature (e.g., beginning at 1000 foot radius, and the radius may be adjusted if targeted objects are not found or too many search objects are returned). In some embodiments, if the searched features (e.g., BFE line features, known flood risk zone boundary line features, river centerline features, dams, levees, and others) are more than 1000 feet away from the property point, a 1000 feet searching buffer may not return a result (the system may search for these features within a radius of the property point). If no result is found, an additional search distance may be added to the search buffer (e.g., an additional 500 feet search distance may be added for a total radius of 1500 feet). If the revised search buffer returns a result, the system may proceed with the result. Otherwise, additional searching distances may be added to the search buffer until a search distance limit is reached. In some embodiments, the 1000 feet searching buffer may return too many features (for example, 750 features may be found) and it may take a significant amount of time to process 750 features to determine the nearest feature. Therefore, the search buffer may be reduced in size (e.g., reduced by 25%) to search again. The search buffer could be repeatedly reduced until a threshold (such as 5) for searching features is reached. In some embodiments, one radius may be searched (e.g., 1000 feet) and if no results are returned the system may continue without expanding the radius. In some embodiments, if a significant number of results are found, the system may determine the closest result(s) to the property point and may proceed.

In some embodiments, the BFE may be determined by interpolating two adjacent BFE line features (e.g., by weighting the two BFEs on either side of the nearest point according to their distances from the nearest points on the BFEs to the property point). In some embodiments, a WSE may be determined (e.g., for coastal areas). In some embodiments, a WSE may be determined by using an elevation of a nearest point (e.g., on a flood zone boundary) to the property point, for example, by determining the elevation using a Digital Elevation Model (DEM). FEMA maps and/or other DFIRMS may be used in calculating the BFE and/or WSE. For example, an elevation may be accessed for the nearest point in the nearest known flood risk zone boundary and used as the WSE. In the case of AO, a water depth may be provided with the zone indication. The provided water depth may be used in a similar fashion as a BFE in determining variances respective to the GE. Other elevations with respect to SFHA or non-SFHA zones may also be determined and used to compare to the property point's GE.

FIG. 11 illustrates various components for BFE and WSE calculations, according to an embodiment. In some embodiments, a WSE may be determined for a calculated point on a known flood risk zone boundary (such as a boundary point 4007 on a known flood risk zone boundary (such as a FEMA SFHA) at an associated cross-section 4013 to a flood source 4001. The cross section pass through the property point 4000 and be substantially perpendicular to the flow of the flood source 4001. Other calculated points are also contemplated. For example, the calculated point may correspond to a nearest point on a nearest known flood risk zone boundary 4003 (river 4001 may also be considered part of the known flood risk zone boundary 4003) to a property point 4000. In some embodiments, a straight-line WSE distance 4009 may be shorter than BFE distances 4011a,b to respective BFE hash mark points 4005a,b and therefore, may provide a more accurate WSE closest to the property point 4000. The WSE may be calculated by first performing a query to determine the proper known flood risk zone boundary (e.g., a known flood risk zone boundary 4003 that is the closest to the property point 4000 and/or may have the most impact on the property point). The elevation of the nearest point on the appropriate known flood risk zone boundary 4015 may be determined by determining a latitude/longitude of the nearest point 4007 and National Elevation Data (NED) (or another elevation data source) may be accessed to determine the elevation of the point 4007 at the known flood risk zone boundary 4015. An elevation may also be determined for the property point 4000 (e.g., by determining the latitude/longitude of the property point 4000 and looking up the elevation for this latitude/longitude in NED). In some embodiments, the USGS elevation dataset (or, for example, a commercial elevation dataset) may be used in determining the GE, BFE and/or WSE. Other points may also be used (e.g., points off of the known flood risk zone boundary 4015) to determine a respective WSE for comparison to the property point's GE.

At 3923, a difference between the GE of the property point 4000 and the BFE/WSE (e.g., corresponding to the calculated point or other respective flood zone point elevation—both SFHA or non-SFHA) may be calculated. For example, an elevation may be determined for the GE of the property point 4000 and the BFE and this elevation may be differenced. In some embodiments, the elevation difference between the property elevation and the elevation of the calculated point on a known flood risk zone boundary (e.g., point 4007 on the known flood risk zone boundary) may be used as a first flood risk characteristic. In some embodiments, the GE may be in a pre-determined elevation variance range that may be either negative (below) or positive (above) in relation to the WSE/BFE. In some embodiments, if a LOMA is applicable, an actual GE to BFE difference may be determined or the GE of the property point 4000 may be considered to be the same as the nearest BFE (effectively resulting in a 0 elevation difference). In some embodiments, an actual GE to BFE difference may be determined by manual research (in some embodiments, the determination may be automated).

At 3925, if the flood zone determination is “SFHA” and the GE of the property point 4000 is less than or equal to the nearest BFE/WSE (BFE/WSE means “BFE or WSE”) or if the flood zone determination is “Non-SFHA” and the GE of the property point 4000 is greater than or equal to nearest BFE/WSE, then the flow may proceed to 3931.

At 3927, if the flood zone determination is “SFHA” and the GE of the property point 4000 is greater than the nearest BFE/WSE, the flood risk score may reflect a decreased risk of flooding. Flow may proceed to 3931 and an option for manual research may be provided. In some embodiments, manual research may be performed to determine if the zone, the GE of the property point 4000, BFE/WSE, and/or property point information are correct (other aspects may also be manually researched). In some embodiments, the flow may proceed to provide an automatic flood risk score (e.g., an automatic assignment of a flood risk score may result, for example, in a score of 600 (which may be the smallest risk score for a property in an SFHA) being assigned for the property point (if in an SFHA)). In some situations, a score may be automatically assigned or may be flagged for additional consideration (e.g., manual research).

At 3929, if the flood zone determination is “Non-SFHA” and the GE of the property point 4000 is less than the nearest BFE/WSE, the flood risk score may reflect an increased risk of flooding. If no LOMA exists, it is possible the flood risk score is higher than for properties in a known flood risk zone boundary zone. Flow may proceed to 3931 and an option for manual research may be provided (in some embodiments, a flood risk score may be provided automatically). In some embodiments, manual research may be performed to determine if the zone, the GE of the property point 4000, BFE/WSE, and/or property point information are correct (other aspects may also be manually researched).

In some embodiments, if the respective SFHA is V*, the flood risk score may be impacted by coastal storm surge (predetermined values for this scenario may be used to impact the flood risk score). In some embodiments, a V zone may represent a high coastal hazard zone subject to high velocity water including waves. In some embodiments, a second risk score component of 25 may be assigned for a V zone to model water velocity impact. If SFHA is AO, the flood risk score may be based on a water depth chart using the same logic as BFE/WSE variances. For example, the provided water depth for the AO or AH zone may be used and a difference between the GE and the water depth may be calculated to determine a first score component. If a LOMA is applied, the GE of the property point 4000 may be set equal to the nearest BFE/WSE (i.e., 0 variance) unless manual determination is requested.

At 3931, a preliminary first score component may be assigned. In some embodiments, based on data related to flood zone determination and elevation difference (e.g., computed using the cross section method, water drop method, surface method, radius search method, etc.), the first score component may be assigned a 100 to 800 number (e.g., on increments of 100) (other numbers, increments, and score types may also be used).

At 3933, additional datasets may be queried. For example, additional flood risk characteristics may be determined. These additional flood risk characteristics may include proximity to a dam, levee, or pumping station, SFHA within n feet, etc. In some embodiments, “proximity” may include determining whether the dam (or other feature) is upstream or downstream from the property point. In some embodiments, when proximity of the water control facilities to a property point is determined, the drainage area of the water control facilities (e.g., as determined from USGS NHD) may be examined. For example, a determination may be made as to whether the property point and the water control facility are in the same drainage area, what the ground elevation difference is between the property point and the water control facility (e.g., whether the ground elevation of the property point is lower than the ground elevation of the water control facility), and distance from the property point to the water control facility. Property points that are not in the same drainage area as the water control facilities or that are above the water control facility (e.g., upstream) may be at a smaller flood risk than property points in the same drainage area and/or below the water control facility elevation. Other considerations are also contemplated. For example, the secondary flood risk score could be varied according the physical factors of the water control facilities (such as year built, built material type, water storage capacity, and others).

In some embodiments, a second flood score component may be assigned (other flood risk components may also be assigned). For example, the second flood score component may be increased by 25 if the property point 4000 is within 1000 feet of a levee. In some embodiments, distances to flood risk zones, distances to flood sources, distances to dams, distances to levees, etc. may be determined using hydrological data sets (e.g., USGS National Hydrological Dataset (NHD)).

In some embodiments, the WSE distance 4009 (or a BFE distance) may be used as a second flood risk characteristic. In some embodiments, the second score component may be impacted by proximity of the property point to major water control facilities (e.g., dams, levees, pumping stations, etc.) based on logic using either catchment data or proximity parameters (which may be assigned based on, for example, past studies or may be arbitrarily assigned) (again, “proximity” may include determining whether the facility is upstream or downstream from the property point). In some embodiments, gage station data may be used and adjusted according to current rainfall to determine the catchment area. In some embodiments, data may be interpolated between the gage stations as needed. Drainage characteristics of the area may also be used with this data to further define the characteristics of the catchment to determine how much the flood risk score should be affected based on the catchment area where the property is located. For example, if a property is in a catchment area that historically had heavy rainfall and flash flooding, the property may have a higher second score component.

In some embodiments, the second score component may account for flood risk decreasing as the distance to the flood source increases. A distance based second score component may reduce uncertainty of the first score components. The hydrological data sets (e.g., USGS NHD) may be integrated to increase the representation of river systems and other bodies of water for the flood risk score engine. The hydrological data sets may be used, for example, to compute proximities from the property points to their flood sources (e.g., river centerlines, river banks, or coastal lines).

In some embodiments, the second score component may supplement the value of the first score component when applicable. The second score component may provide an additional risk analysis for the property point 4000. The second score component may not be static for each property point 4000, but may change depending on the flood zone of the property point 4000 and/or other features of the property point 4000 (e.g., as determined by other datasets).

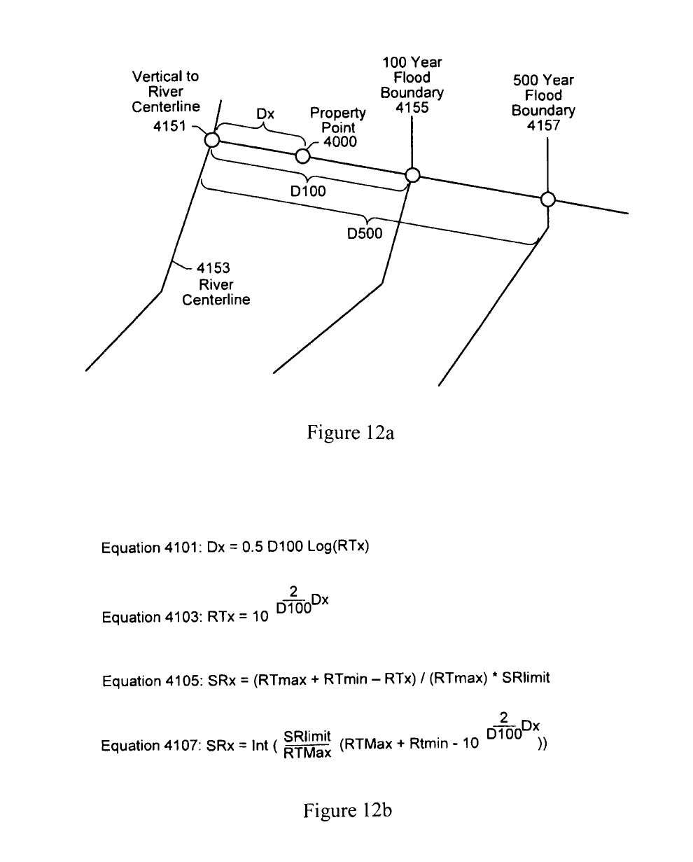

In some embodiments, the second score component may be computed according to equation 4103 provided in FIG. 12b. In some embodiments, Dx is a distance from a river bank or centerline 4153 (e.g., see FIGS. 41a-41e of application Ser. No. 12/027,096), D100 is a distance from the river bank or centerline 4153 to a nearest 100-year flood boundary 4155, RTx is a return period at the property point x, RTmin is a minimum flood return period in the computation (e.g., 1 year), RTmax is a maximum flood return period in the computation (e.g., 1000 year), SRlimit is an upper limit of a second score component in the computation (e.g., 75), and SRx is a second score component at a property point x. If RTx is 1, Dx may be 0. If RTx is 100, Dx may be D100 (e.g., according to equation 4101). Equation 4101 may also be written in the form of equation 4103. In some embodiments, an upper limit may be set for the second score component (e.g., 75). In some embodiments, the second score component may not have an upper limit. In some embodiments, the upper limit may be distributed by return period (e.g., RTmin is 1 and RTmax is 1000). If RTx is equal to RTmin, SRx may be set equal to 50. If RTx is equal to RTmax, SRx may be set equal to 0. In some embodiments, equation 4107 (Int returning the closest integer value) may be used (e.g., for second score components for 0<Dx<1.5*D100, when Dx>1.5*D100, SRx=0). Equation 4107 may also be used for other second score components.

In some embodiments, the relationship between the proximity of the property location to its flood source(s) and the second score component may be formulated according to a logarithm equation (e.g., equation 4101) based on the known distance between the boundary point on the known flood risk zone boundary (e.g., an SFHA corresponding to the 100 year flood boundary) at the associated cross-section to its flood source. As seen in FIG. 12a, calculating a second score component may include using a distance from the property point 4000 to a flood source (e.g., a river bank or centerline 4153) and a distance from a 100-year flood boundary 4155 to the flood source. To compute the distances, a line object may be created from the property point 4000 to the river bank or centerline 4153 (which may be a flood source). The line object may be created perpendicular to the river centerline 4151. The line objects may be extended across the 100-year boundary and/or the 500-year flood boundary 4157 (if it exists). The intersect points may be used to compute the distances to the river centerline 4153 (e.g., using a digital map to determine, e.g., a straight-line distance between the property point 4000 and the intersect points). In some embodiments, the intersect points may be used to query elevation datasets to determine a 100 year WSE and 500 year WSE. The elevations may be validated at the intersection points (e.g., elevation at the river may be less than the GE of the property point 4000).

In some embodiments, a non-SFHA property with a distance to a nearest SFHA<500 feet may have it's flood risk score impacted more (e.g., through the second flood risk component) by the distance to the SFHA than a non-SFHA property with a similar elevation variance (e.g., similar elevation difference to nearest BFE) that is ≧500 feet from the nearest SFHA. In some embodiments, a non-SFHA property with a distance to a nearest SFHA>500 feet but less than 1000 feet may have its flood risk score impacted more (e.g., through the second flood risk component) by the distance to the SFHA than a non-SFHA property with a similar elevation variance (e.g., similar elevation difference to nearest BFE) that is ≧1000 feet from the nearest SFHA.

Property Point Collection

FIG. 13 is a flowchart describing a top-level process for using a mobile electronic device to either verify and/or supplement information regarding property location such as structures at a particular parcel, where position information and other information is input onto a mobile device, such as when an operator is located at the parcel. The process begins with an optional Step 2201 where the operator uses the mobile device to capture a photo of the structure. This photo may be used to verify whether changes have been made to the structure since a last recording of the structure has been made. A stored photo may be presented on the tablet computer, to inform the operator of what images are presently stored.

The process then proceeds to Step 2203 where the mobile device is used by the operator for the operator to input and/or verify the property location such as structural attributes, which is saved as property attribute data. This may include information such as additional structures added to the property, or additions such as garages, etc. that have been added to the structure since the last recording or aerial image had been captured. The process then proceeds to Step 2205 where the operator also verifies and inputs information regarding surrounding features that may affect the flood risk score. This information may include things such as community flood mitigation efforts such as retaining walls, etc., private flood mitigation techniques such as installation of sump pumps, creation of ditches, etc. that would shunt water away from the structure. The process then proceeds to Step 2207 where the operator inputs GPS position (e.g. lat/long), at a single or multiple position points about the structure. These position points may be located at corners of the building (outline of footprint) or at a single or multiple points within the building, for example, at interior positions such as the centroid of the improvement. The process then proceeds to Step 2209 where a flood risk score is determined for each of the different position points (which may include the combination of primary and secondary risk factors) at the structure locations previously recorded in Step 2207. The process then proceeds to an inquiry of Step 2211, where other GPS location information is input, if available, then the process returns to Step 2209 for determining the flood risk score for that new location. However, if all of the GPS (position point) locations have been exhausted for that particular parcel, the process proceeds to Step 2213 where post-FRS processing is performed, such as determining the highest flood risk score of a plurality of flood risk scores to report, averaging of a specific plurality of flood risk scores, or the calculation of estimated financial risk for the property are determined. The process then stops.

The details of Step 2203 are shown in the process flow at FIG. 14. Here the process begins at Step 2301 where the mobile device retrieves from a remote database or perhaps a computing resource, attributes of the subject property in Step 2301. The process then proceeds to optional Step 2305 where verification is performed by the operator verifying the building type. If the building type is incorrectly saved as an attribute of the subject property, the operator overrides that description by correcting the building type. Example building types might be commercial or residential, for example. The process then proceeds to optional Step 2307 where the mobile device has displayed any recorded improvements or damage to the particular structure. This is an opportunity for visual inspection of the parcel to determine whether the description of the parcel is accurate with regard to measures taken to avoid floods, or pre-existing damage exists to the structures.

The process then proceeds to an inquiry of Step 2309. In Step 2309 if a difference is observed the process proceeds to Step 2311 where the discrepancy is recorded, but if no difference is observed the process proceeds directly without recording a discrepancy to Step 2313. In Step 2313 the mobile device has displayed thereon the recorded information/deterioration to the surrounding property recorded for that particular property. Unlike the previous steps in this flowchart, this step includes the display of the surrounding property, as opposed to the structure.

The process then proceeds to a query in optional Step 2315 where the difference is observed visually with regard to the recorded improvement/deterioration, the discrepancy is recorded in Step 2317. Otherwise the process proceeds to Step 2319 where a bearing angle from a particular position point is recorded to the nearest flood source. This bearing angle is useful in assisting in determining the flood risk score for that particular parcel. For example, the bearing angle may be helpful to show the likely direction from which the flood waters would begin to encroach on the improvement. As such, more valuable portions of the improvement or chattels contained in that part of the improvement may be relevant to the inherent flood risk for that particular property. As a specific example, the bearing angle from the flood source to the improvement may place a carport as being the earliest feature of the improvement that is subject to flood damage. This would result in a less risky flood score than if the bearing angle indicated that the flood waters would likely first encounter a computer server room, which could result in catastrophic loss early in the flooding process. Also, by knowing the direction that the flood waters will approach, and the value of the portion of the improvement that will likely first be subject to flooding, gives the landowner an opportunity to take some measures to limit the flood damage perhaps by using water barrier techniques (sandbags) or perhaps by moving the most valuable belongings to higher ground. The process then stops.

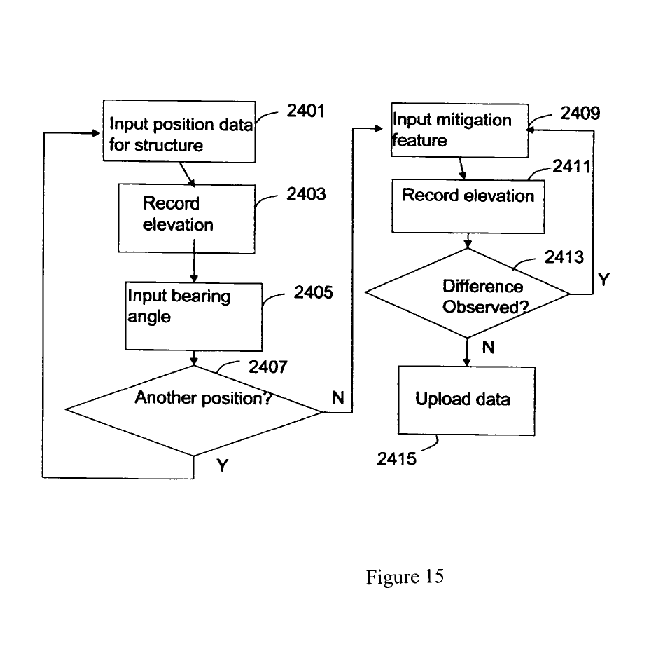

FIG. 15 is a flowchart describing on a position point by position point basis the recording of the position points around the structure. The process begins at Step 2401 where the input position data for the structural feature is recorded from GPS module in the mobile device. The process then proceeds to Step 2403 where the elevation for that particular position point is recorded in association with the latitude and longitude position of the position point. Also the operator records the bearing angle in Step 2405 for that position point with respect to the flood risk feature most prevalent at that particular parcel. For example if a stream is located at the edge of one property, the bearing angle would be from the particular position point towards that stream. The process then proceeds to Step 2407 where a query is made regarding whether there is another position point for the structure to be processed. If so, the process proceeds to return to Step 2401. Otherwise the process proceeds to Step 2409 where the position data of the flood mitigation features, if any, are collected via the mobile device and the operator actuating the mobile device to record the position data. Then at Step 2411 the elevation for the particular flood mitigation feature is recorded. Exemplary flood mitigation features may include retaining walls, culverts, retaining ponds, etc. The process then proceeds to a query in Step 2413 regarding whether there is another flood mitigation feature to be observed. If so the process returns to Step 2409. Otherwise the data is uploaded to a server that collects and stores the data for later use in calculating flood risk score for a particular parcel. This uploading of data is performed at Step 2415.

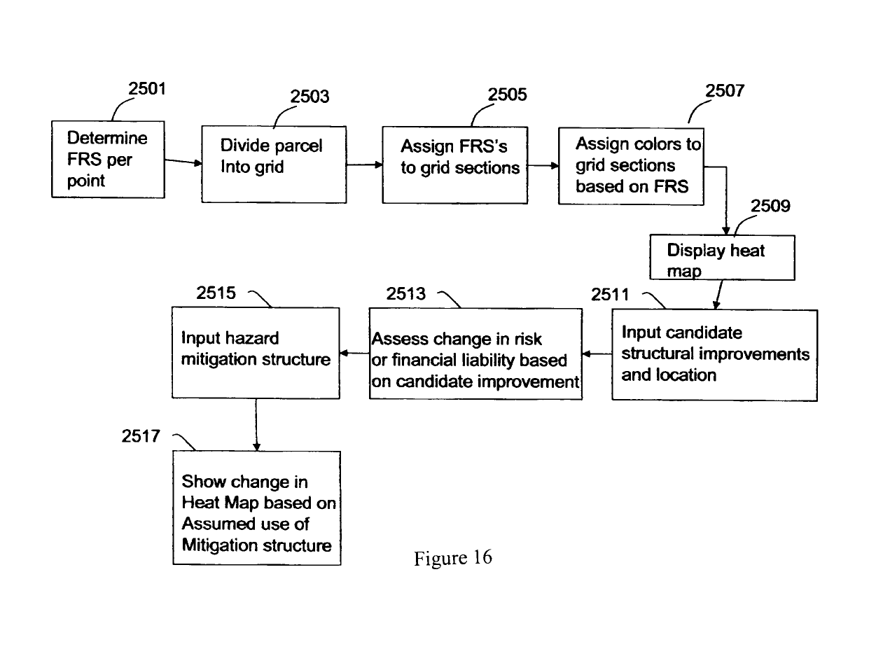

FIG. 16 is a process for creating a “heat map” that shows a distribution of flood risk scores across a property. Moreover, because a particular property will have multiple position points recorded thereon, each position point having a flood risk score associated therewith, the parcel may be divided up into particular sections (or sub-areas), each section having a separate FRS that may be coded in a convenient way such as color to indicate what portions of the property are most susceptible to flood risk.

The process begins in Step 2501 where the FRS is calculated for each position point. Then in Step 2503 the parcel is divided into a grid and in Step 2505 FRS are assigned to each grid section. This would involve collecting at least one position point for each grid section. However, if a grid is absent a particular FRS, an interpolation between adjacent FRSs from adjacent grid sections may be used to “fill the gap”. The process then proceeds to Step 2507 where a color is assigned in conjunction with each section based on the flood risk score for that particular grid section. For example red is assigned to a section that has a high flood risk score (e.g., 50). Yellow is assigned to a moderate FRS (e.g., 30) and green is assigned to FRS of 20 or less for example.

The process then proceeds to Step 2509 where either on the mobile device (FIG. 3), or any of the computers accessible by a network shown in FIG. 1 may have the heat map displayed thereon. Moreover, a display of the parcel (or group of parcels) may have a graphics overlay of the heat map, showing the FRS color distribution across the particular property or properties being viewed.

The process then proceeds to Step 2511 where, optionally, additional input may be received regarding candidate structural improvements at particular locations on the property.

For example, a user may select from a group of candidate structural improvements (e.g., retaining walls), that if placed at a particular location on the property, would allow the user to observe how that candidate structural improvement may result in a change in the heat map. This change may be assessed in Step 2513 where a change in the flood risk colors on the heat map may reflect how the structural improvement changed the assessed flood risk score if the candidate structural improvements were provided. Optionally the change in FRS value may also be used to display a change in insurance premium based on the candidate structural improvement and location for that improvement. This would allow the end user to see if the cost of the candidate improvement is worth the change in the insurance premium for the property. The process then proceeds to Step 2515 where the user selects the candidate flood mitigation structure followed by Step 2517, where the heat map is changed based on the assumed use of the candidate flood mitigation structure. The process then ends.

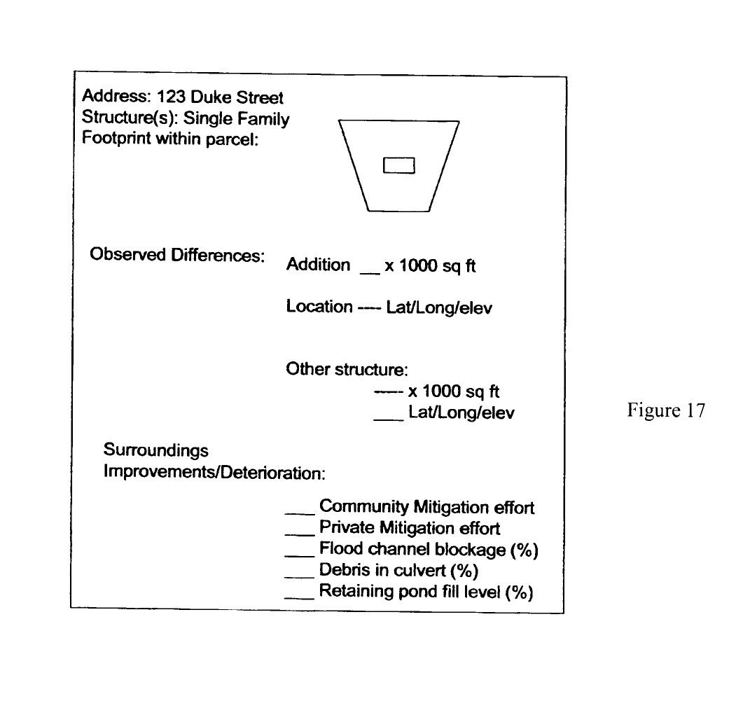

FIG. 17 is an exemplary graphical user interface, of the touch screen 381 used by the operator assessing the particular property being analyzed. The GUI includes opportunities to observe whether or not the footprint of the parcel appears to be consistent with the stored structural description. It also allows for the operator to record differences between what has been stored regarding the structures for that particular parcel with what the operator sees while at the property. This may include things like an addition to the house, or other structures added such as swimming pools, other buildings, etc. The GUI also includes surrounding improvements/deteriorations that would bear on the FRS for the particular parcel.

Obviously, numerous modifications and variations of the present invention are possible in light of the above teachings. It is therefore to be understood that within the scope of the appended claims, the invention may be practiced otherwise than as specifically described herein.

1. An electronics apparatus that collects property point information for a hazard assessment, said apparatus comprising:
an interface that receives input data from an external source;
a non-transitory storage device; and
a positioning module that records in said storage device property point information about a present location of said electronics apparatus in response to said interface receiving said input data, wherein
said non-transitory storage device stores one or a plurality of position points on a parcel that are used by a processing circuit in determining at least one flood risk score for said parcel.

2. The apparatus of claim 1, wherein
said positioning module is a global positioning system module hosted in at least one of a smartphone and a tablet-computer.

3. The apparatus of claim 2, wherein
said positioning module records position point information for each of a plurality of points on said parcel, and said position point information is used in determining said at least one flood risk score for said parcel.

4. The apparatus of claim 2, wherein
said positioning module records position point information for each of a plurality of corners of a footprint of a structure on said parcel, and said position point information is used in determining said at least one flood risk score for said parcel.

5. The apparatus of claim 2, wherein
said positioning module records position point information for any point on or within a footprint of a boundary of a structure on said parcel, and said position point information is used in determining said at least one flood risk score for said parcel.

6. The apparatus of claim 1, further comprising:
the processing circuit that uses as input said plurality of position points when determining said flood risk score for said parcel.

7. The apparatus of claim 1, wherein:
said interface outputs said plurality of position points to a remote computer which determines said flood risk score for said parcel.

8. The apparatus of claim 1, further comprising:
a display that displays
a footprint of a building on said parcel, and
an indication of said present location.

9. The apparatus of claim 8, wherein
said display and said interface being incorporated into a touchpanel display.

10. The apparatus of claim 1, further comprising:
a touchpanel display that includes said interface, wherein
said touchpanel display receives property attribute data for use in determining said flood risk score.

11. The apparatus of claim 10, wherein
said property attribute data includes at least one of
bearing angle from the present location to a flood risk source, elevation difference between at least two points of the plurality of points, and
presence of a flood risk mitigation feature.

12. The apparatus of claim 10, wherein
said touchpanel display includes a template for indicating at least one of
observed differences between stored building attribute data and presently observed building attribute data, and
observed differences between stored surroundings information and presently observed surroundings information for said parcel.

13. The apparatus of claim 8, wherein
said positioning module records position point information for each of a plurality of corners of said footprint, and said position point information is used in determining said flood risk score for said parcel.

14. The apparatus of claim 8, wherein
said positioning module records position point information for a centroid of a boundary of said footprint, and said position point information is used in determining said flood risk score for said parcel.

15. The apparatus of claim 8, wherein
said display displays a heat-map of said parcel divided into a plurality of sub-areas having colors that correspond to an associated flood risk score for a respective sub-area.

16. A method for collecting position point information for a hazard assessment, said method comprising:
receiving data via an interface of a mobile electronics device;
storing said data in a non-transitory storage device;
recording with a positioning module position point information about a present location of said mobile electronics device in response to said receiving;
storing a plurality of position points in said non-transitory storage device; and
determining a flood risk score for said parcel based on said plurality of position points.

17. The method of claim 16, wherein
said determining includes sending said plurality of position points to a remote computer to determine said flood risk score.

18. The method of claim 16, wherein
said determining includes determining said flood risk score with a processing circuit in said mobile electronics device.

19. The method of claim 16, further comprising:
displaying on a touchpanel display
a footprint of a building on said parcel, and
an indication of said present location.

20. The method of claim 19, further comprising
inputting property attribute data for use in determining said flood risk score, wherein said property attribute data includes at least one of
bearing angle from the present location to a flood risk source, elevation difference between at least two points of the plurality of points, and
presence of a flood risk mitigation feature.

21. The method of claim 19, wherein
said displaying includes displaying a template for indicating at least one of
observed differences between stored building attribute data and presently observed building attribute data, and
observed differences between stored surroundings information and presently observed surroundings information for said parcel.

22. The method of claim 19, further comprising
recording position point information for each of a plurality of corners of said footprint, and
using said position point information in determining said flood risk score for said parcel.

23. The method of claim 19, further comprising
displaying on said display a heat-map of said parcel divided into a plurality of sub-areas having colors that correspond to an associated flood risk score for a respective sub-area.

24. A non-transitory computer readable storage device having instructions that when executed by a processing circuit implement a method for collecting position point information for a hazard assessment, said method comprising:
receiving data via an interface of a mobile electronics device;
storing said data in a non-transitory storage device;
recording with a positioning module position point information about a present location of said mobile electronics device in response to said receiving;
storing a plurality of position points in said non-transitory storage device; and
determining a flood risk score for said parcel based on said plurality of position points.
